(19) United States
(12) Patent Application Publication
(10) Pub. No.: US 2007/0061119 A1
(43) Pub. Date: Mar. 15, 2007

(54) Molecular simulation method and apparatus

(75) Inventors: Jiro Shimada, Tokyo (JP); Hiroaki Fukunishi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/520,588

(22) Filed: Sep. 14, 2006

(30) Foreign Application Priority Data
Sep. 15, 2005 (JP) 2005-268356

(51) Int. Cl. G06G 7/48; G06G 7/58

(52) U.S. Cl. 703/11; 703/12

(57) ABSTRACT

In molecular simulation including the step of calculating non-bonding interactions in a system having particles with electric charges, using a multigrid method, upon determining the electric charges at grid points in a coarser grid of a higher level that is one step higher than the level to be observed, when a pair of grid points in the observed level, or a pair of particles in the observed level, both coincide with the grid points of the grid of the higher level, the charges at the grid points of the higher level are determined so that the energy of the pair in the higher level becomes equal to the correct energy value in the observed level.

### BACKGROUND OF THE INVENTION

1. First of the Invention

The present invention relates to a method and apparatus for carrying out molecular simulation based on molecular dynamics simulation or a molecular Monte Carlo method, and in particular relates to improvement of a multigrid method used for high-speed computation of nonbinding interactions.

2. Description of the Related Art

General Techniques in Molecular Dynamics Simulation:

Molecular dynamics (MD) simulation of biomolecules is also called molecular simulation, and it is one of the important methodologies that are used for molecular design of remedies against diseases, useful enzymes and the like. The model that is used in the molecular simulation is a so-called molecular mechanics (MM) model.

Describing this molecular mechanics model briefly, molecules to be handled, such as proteins, and water molecules are modeled by beads (particles) connected with springs while the beads, meaning atoms constituting molecules are assigned with electric charges. When the molecular mechanics model is used, the energy in a molecular system can be roughly classified into the bonding interaction and the non-bonding interaction. Of these, bonding interaction is an interaction that is accompanied by change of a bond length, bond angle, bond dihedral angle etc. On the other hand, examples of non-bonding interaction includes Coulomb interactions and van der Waals interactions.

In molecular simulation, the initial conformations of the atoms in molecules are determined while electric charges are assigned to the individual atoms that constitute the molecules to specify the initial conditions. Then, how each molecule moves (e.g., deforms) from the initial condition by the aforementioned bonding interaction and non-bonding interaction and how the energy in the system changes along with the movement of molecules is computed. Execution of molecular simulations from various initial conformations makes it possible to determine the conformation of the molecule that is finally most stable. This provides, for example, important information to estimate the interaction between a protein and a medicine that acts as a ligand for the protein as well as information for estimating the function of a protein itself.

In a case where a molecular simulation of a typical protein molecular system is carried out, most of computation time is occupied by computation of non-bonding interactions, in particular, Coulomb interactions. When the atoms included in a system to be observed are allotted with numbers in order and the charge on each atom, i.e., partial charge, is represented by qᵢ, the Coulomb interaction energy U is given by the following equation:
U=ΣᵢΣⱼqᵢqⱼ/rᵢⱼ (1),
where rᵢⱼ is the distance between atom i and atom j and summation over i and j is taken under the condition of i<j. The values of partial charges can be determined by a theoretical technique such as a molecular orbital (MO) method etc., or by an empirical technique based on fitting with experimental data. When the number of atoms in the system is N, the computational complexity for the Coulomb interaction can be represented as O(N²). That is, the amount of computation is proportional to N².

The reason the Coulomb interaction is particularly important is that the Coulomb interaction is a long-range interaction that is inversely proportional to the square of the distance, and the pairs of particles that interact to each other become enormous in number. In contrast with this, the van der Waals interaction is a short-range interaction that inversely proportional to the sixth power of the distance, so that the number of particles to be considered for computation becomes much smaller, hence the computational complexity is much smaller compared to the case of Coulomb interaction.

In order to extract a significant result from the result that has been obtained by the aforementioned molecular simulation, at least one million steps, when assuming one calculation over all the molecules as one step, preferably 1000 times of that, should be iterated, which needs a very enormous time of computation. For this reason, there has been a strong demand for high-precision, high-speed calculation technique of non-bonding interaction in order to make use of molecular simulation in the field of molecular design of medicines and the like. It should be noted that, since bonding interaction is an interaction between atoms that are directly connected each other by chemical bonds, the number of particle pairs to be computed are much smaller than that for non-bonding interaction.

In order to meet the demand for enormous amount of computation with regards to non-bonding interaction, various kinds of algorithms have been proposed for software for molecular simulation and put in practice. Also, as the hardware for performing :molecular simulation, so-called PC (personal computer) clusters, the Earth-Simulator, BlueGene, a product of IBM have been made use of. As dedicated hardware, MD engine, a product of Fuji Xerox Co., Ltd. and MDGrape, a product of Riken and the likes have been developed. However, any of the software techniques and the hardware techniques has not yet a high enough speed in view of implementation of molecular simulation, there is a strong demand for a further speed enhancement.

Two Kinds of Tyipical Boundary Conditions in Molecular Simulation:

There are two kinds of typical boundary conditions that are frequently used in molecular simulation, namely, periodic boundary condition and vacuum boundary condition.

A periodic boundary condition corresponds to a model in which molecules to be considered are arranged periodically as in a crystal, for example. Under a periodic boundary condition, calculation techniques such as FFT (fast Fourier transform) etc. can be used because of the feature of the periodic arrangement, hence it is considered that the calculation speed can be improved with such techniques.

A vacuum boundary condition is applied to a calculation for a so-called isolated system. A typical example is a system in which a molecule to be considered (e.g., protein molecule) is immersed in a large spherical solvent placed in vacuum. The solvent is typically water. Use of a vacuum boundary condition is generally supposed to take a longer time for computation, but is also considered to enable fast computation in simulating change of conformation in a molecule.

In any way, the periodic boundary condition and the vacuum boundary condition are both artificial, so that whether they are suited or not depends on a case-by-case basis, and also it has been pointed out that either condition has problems. This is why there is a demand for a computational algorithm that can be applied to both the boundary conditions for periodic systems (periodic boundary condition) ahd isolated systems (vacuum boundary condition).

Existing Algorithms for Periodic Boundary Conditions and Their Problems:

As an efficient algorithm for periodic boundary conditions, PME (particle mesh Ewald) method of Darden et al. (1995) [1] is famous. In this method, a potential is divided into the particle-particle portion in which direct calculations are performed between particles and the remaining smooth portion in which particles are mapped on a mesh so as to perform fast calculation of convolution type computation by using 3D-FFT (three-dimensional fast Fourier transform) to thereby perform efficient calculation of particle-mesh interactions as final results.

The PME method is an excellent method that is implemented in an MD code (computer code for molecular simulation) “Amber”, which is used widespread in the field of biosimulation but also implemented in other various MD software applications. The parallelizing capability, i.e., parallelization processing capability of computation, of the PME method is markedly excellent in a PC cluster consisting of approximately 16 to 32 PCs. However, there remains the problem that if the cluster system is greater in scale than this, the parallelization ratio becomes lower and the system becomes inefficient. The cause is that it is difficult to achieve parallelization of 3D-FFT computations with a large number of CPUs, hence resulting in a poor parallelization ratio. In BlueGene of IBM has special hardware design to enable 3D-FFT fast computation in order to avoid this reduction in parallelization ratio.

Existing Algorithms for Vacuum Boundary Conditions and Their Problems:

On the other hand, as an efficient algorithm that can be applied to a vacuum boundary condition (i.e., an isolated system), there has been a method called Fast Multipole Method (FMM) proposed by Greengard et al. [2], which is implemented in “Charmm,” which is another famous MD code different from “Amber”, and the like. However, since the FMM cannot help but calculate an enormous number of high-order terms of multipole expansion, the speed of computation becomes slow even though the computational complexity of this method is regarded as O(N), i.e., the amount of computation is proportional to N. Here, N is the number of atoms that are contained in the system. It is more difficult to handle an isolated system than a periodic system because 3D-FFT cannot be used, hence it is difficult to speed up the computation even when the number of CPUs for parallel computation is less than 16 or 32. In actual cases, MD code “Amber” has not been implemented with the fast multipole expansion method. Most of the users execute computation by cutting off non-bonding interactions between two particles if they exist more than a certain distance apart from each other, or by using a dedicated computation board such as an MD engine etc., to achieve accurate computation without cutoff.

Also, in order to enable application of the computational method for periodic systems to an isolated molecular system such as that consisting of a spherical solvent such as water and proteins therein, it is possible to consider a system in which such isolated molecular systems are arranged periodically. Such a periodic arrangement makes application of FFT etc., possible. In this case, however, in order to eliminate interactions between the molecules which should be inherently isolated but are assumed to exist periodically, the conventional method need to set up the interval between the molecules in the periodical structure to be greater than the size of the molecular system, as a result, it is necessary to effect FFT with a greater number of points, giving rise to a problem that the amount of computation is too great. For this reason, proposals of the idea of arranging such isolated molecular systems periodically have been made [3], it is seldom that this idea is put into practice.

Emergence of Dedicated MD Boards and Their Problem:

As dedicated hardware for directly implementing fast computation of particle-particle interactions in MD computation, various kinds of dedicated MD boards have been developed and put on the market. There are configurations in which computation is performed by combination of a dedicated board with a methodology that is devised from an algorithm viewpoint such as the aforementioned PME, FMM and the like. However, there remains a large proportion of incalculable part with the dedicated board in PME or FMM, so that increase in computation speed degrades in the case when an algorithm is used in combination, compared to the case where no algorithm is combined. As a result, there turns up strong demand for a technique that is suited to a dedicated board, other than PME and FMM.

Emergence of Multigrid Methods and Their Problem:

At the strong request for speedup and large-scale parallelization, Skeel et al. have recently proposed a high-speed technique based on a multigrid method [4]. Multigrid methods can be applied to computation of van der Waals forces as well as to that of the Coulomb force when a special mixing rule is adopted for van der Waals parameters in a molecular mechanics model. However, as will be seen hereinbelow, the method of Skeel et al. has a serious weakness in accuracy though it is high in speed, hence it was impossible to achieve the necessary precision in practical use.

Now, the algorithm by Skeel et al. will be described in three steps.

Separation of a Potential into Long-range Type and Short-range Type:

The basic idea of the algorithm of Skeel et al. is an application of a multigrid method that has been developed from the 1970s. In this method, when the potential function to be computed is a function of inter-particle distance r of the Coulomb type, or more specifically, the function is inversely proportional to distance r, an original potential function G(r) (=1/r) is separated into two components, as shown in FIG. 1A, namely a smooth function G_{R}(r) which has no singularity at the origin and a function G^{S}R(r) representing the remaining component:
G(r)=G_{R}(r)+G^{S}_{R}(r)=(long-range type)+(short-range type) (2),
where, R is a parameter called a shielding radius. The long-range type function G_{R}(r) should have properties that it smoothly converges to the original function G(r)=1/r as r becomes greater and totally coincides with the original function especially when r is equal to or greater than distance R while it is more smoothed in the vicinity of the origin as R is greater (see FIG. 1B). As a result, the short-range type function G^{S}_{R}(r)=G(r)−G_{R}(r) takes non-zero values where r is equal to or less than distance R and smoothly converges to zero at distance R (see FIG. 1A). The short-range type function will be handled as inter-particle interactions and the long-range type function will be handled by way of grid representation as described below. Here, the super script S indicates “Short-range” and “Split”. This potential function will hereinbelow be called kernel by custom.

Hierarchical Grid Structure:

In general, in most of molecular simulations, a particle system to be considered is divided by a grid so that computation is efficiently performed for every cells. Grids also called cells, meshes and the like. One general feature of a multigrid method is that the system is not divided by a single grid but divided using fine grids for low levels and coarse grids for high levels. Specifically, in a grid system of level L, a grid having a size of a power of 2 times (2^{L-1} times) the size (with respect to the length not volume) of the level 1 is used (see FIGS. 2 and 3). The finest grid has a mesh size of 0.1 nm, for example.

Hierarchical Splitting of a Potential:

The idea of Skeel et al. is that the long-range kernel that has been once smoothed and separated is further divided in a successive manner. This will hereinbelow be described specifically. For each hierarchical grid level L shown in FIGS. 2 and 3, long-range kernels with shielding radii set at the powers of 2:
tR=2^{L}R,
that is, R, 2R, 4R and 8R, are introduced. Further, short-range kernels G^{S}_{tR}(r) are separated successively, according to the following equations.
G(r)=G_{R}(r)+G^{S}_{R}(r) (level 0)
G_{R}(r)=G_{2R}(r)+G^{S}_{2R}(r) (level 1)
G_{2R}(r)=G_{4R}(r)+G^{S}_{4R}(r) (level 2)
G^{S}_{Rmax/2}(r)=G_{Rmax}(r)+G^{S}_{Rmax}(r) (level Lmax-1) (3),
where, Rmax is the shielding radius for the maximum level Lmax:
Rmax=2^{Lmax}R (4).

FIG. 1B shows examples of the functions of long-range kernels. From a geometrical viewpoint, the successive separation in FIG. 1B corresponds to division of the area between 1/r and the lateral axis into parts bounded by curves G_{R}, G_{2R}, G_{4R} and the like. Specifically, short-range kernels G^{S}_{tR} will be calculated according to the following equations:
G^{S}_{R}(r)=G(r)−G_{R}(r) (level 0)
G^{S}_{2R}(r)=G_{R}(r)−G_{2R}(r) (level 1)
G^{S}_{4R}(r)=G_{2R}(r)−G_{4R}(r) (level 2)
G_{Rmax/2}(r)=G_{Rmax/4}(r)−G_{Rmax/2}(r) (level Lmax-1) (5),

For convenience, the following notation will be used hereinbelow:
G^{S}_{Rmax}(r)=G_{Rmax/2}(r) (level Lmax) (6).

That is, the subscript Rmax actually corresponds to the long-range kernel but superscript S is added in order to indicate that it is a split kernel.

The original potential G(r) can be written as the summation of short-range kernels for different levels:
G(r)=G^{S}_{R}(r)+G^{S}_{2R}(r)+G^{S}_{4R}(r)+. . . + G ^{S}_{Rmax/2}(r)+G^{S}_{Rmax}(r) (7).

FIG. 1C shows examples of the functions of short-range kernels obtained in the above manner.

A Multigrid Example for an Isolated System:

FIG. 2 shows an example of a multigrid for an isolated system with short-range kernels corresponding to individual grid system levels. Conforming to separation of kernels, the total (Coulomb) interaction energy is also separated:
U=U^{S}_{R}+U^{S}_{2R}+U^{S}_{4R}+ . . . +U^{S}_{Rmax/2}+U^{S}_{Rmax} (8),
where
U^{S}_{tR=(}½)ΣᵢΣⱼqᵢqⱼG^{S}_{tR}(rᵢⱼ) (particle system) (9).

The basic idea of the multigrid method is that the thus separated interactions can be handled efficiently by coarsely graining electric charges over the grid systems of the corresponding levels in accordance with the degrees of smoothness of the kernels. That is, the energy for the grid system of level L⁻ equal to or higher than level 1 should be calculated according to the following equation, by assigning appropriate electric charges at the grid points in level L, instead of using the charges on the original particles:
U^{S}_{tR}=(½) Σₖ Σₘ q′ₘ q′ₖ G^{S}_{tR}(nₖ₋nₘ) (grid system) (10).

Here, q′ₖ and q′ₘ are charges at grid points, and nₖ and nₘ are position vectors of the grid points. From now on, unless otherwise specified, i and j represent particle numbers, and k, I and m represent grid point numbers. It should be noted that interaction energy U^{S}_{R} at level 0 should be calculated directly on the particle system.

A Multigrid Example for a Periodic System:

FIG. 3 is a diagram for illustrating the whole of an existing algorithm by Skeel et al. by using grid systems for a periodic system. The upward path on the left side in FIG. 3, or the path represented at “(1)” shows the step in which the charges at grid points are assigned to the grid points at the upper coarse level while the downward .path on the right side in the figure, or the path represented at “(3)” shows the step in which the potentials, electric fields and forces at grid points at the lower fine level are determined by interpolation. In the figure, a charge at a grid point is represented with a solid circle, a potential or force at a grid point is represented with a solid square. The size of the solid circuit representing a charge corresponds the amount of charge at that grid point, and the size of the solid square representing a potential or force corresponds to the magnitude of the potential or force at that grid point. Further, the horizontal paths in FIG. 3, that is, the paths indicated by “(2)” and “(4)” show the steps of calculating grid interactions by using the interaction kernel at the corresponding level. In the following description, the step in which charges are assigned to the grid of a coarse level will be called an upward path; the step in which interactions acting between grid points at the same level are calculated so as to determine electrostatic potentials acting at the grid points will be called a horizontal path; and the step in which electrostatic potentials over the grid of a fine level are successively interpolated from the electrostatic potentials obtained at the grid points at the coarse level will be called a downward path. The actual operation of a downward path comprises the steps of determining electrostatic potentials at the level being considered by interpolation of the potentials at the level one level higher or coarser and adding it to the electrostatic potentials at that level that are derived by the horizontal path at the same level.

The Problem to be Solved by the Present Invention:

The multigrid method of Skeel et al. [4] provides fast computation but entails the problem of low accuracy. Particularly, there is the problem that the energy accuracy is low. Therefore, the present invention is aimed at attaining the following three objects.

The first object relates to improvement against the low accuracy of the multigrid method of Skeel et al. When there is a grid point k near atom i having charge qᵢ and the position vector at grid point k is represented by nₖ, the method of Skeel et al. weights the charge with basis function W(rᵢ−nₖ) to assign charge q′ₖ to grid point k. Here, rᵢ is the position vector of atom i. The assignment of charge q′ₖ can be represented as the following equation:
q′ₖ=Σᵢqᵢ W(rᵢ−nₖ) (11).

Here, the function W used for weighting (written as φₖ in the original paper of Skeel et al. [4]) is a basis function having a local support. That is, the function has non-zero values within a local finite interval only. Some examples of such basis functions are described by Skeel et al., and a typical example is a third order B-spline function having piecewise polynomial function properties, presenting non-zero values in the vicinity of a particular grid point only. However, according to the report of the numerical experiment by Skeel et al., the result of calculations obtained for some kinds of basis functions presented poor accuracy with its precision inferior two to three orders of magnitude lower to that to be needed at present.

Though it depends on the object of molecular simulation, it is considered that the simulation result for forces needs a relative accuracy of at worst about 1 ×10⁻³ and that the simulation result when it is compared with free energy needs a relative accuracy of at worst about 1×10⁴. In order to use the simulation result with confidence, it is regarded that a relative accuracy of about 1×10⁻⁵ to 1×10⁻⁶ is. needed. In contrast to this, the result from Skeel et al. presented a relative accuracy of, at best, 6×10⁻⁴, which barely measures up to the lowest condition, but it is the current situation for this method to take a longer time for computation to output the best performance. There is also a report that the method of Skeel et al. is able to attain fast computation up to a relative accuracy of about 1×10^{31 3} but exhibits inferiority. in speed to the PME method and the like if a higher precision than the above is required. In one word, it is necessary to develop a multigrid method which can achieve fast computation with high accuracy.

The second object is to improve the present situation, in which there is no fast computation method for isolated systems.

The third object is to develop a multigrid method that will be suited to hardware of dedicated boards, in consideration that it is difficult for the PME method and FMM method to achieve fast computation with a dedicated MD board.

Examples of Patent Literatures Relating to Molecular Simulation:

WO97/46949 discloses a molecular modeling system having an apparatus for performing molecular mechanics computation. Japanese Patent Application Laid-open No. 2000-268064 (JP-A-2000-268064) discloses a method for generating the initial arrangement of particle clusters when molecular simulation is performed. Japanese Patent Application Laid-open No. 2002-80406 (JP-A-2002-080406)and Japanese Patent Application Laid-open No. 2003-12566 (JP-A-2003-012566) disclose implementation of molecular simulation using 12-6 Lennard-Jones potential for non-bonding interactive forces in order to predict a higher-order structure of a long-chain molecule such as a polymer, leuco dye etc. Japanese Patent Application Laid-open No. Hei8-63454 (JP-A-08-063454) discloses a particle simulation method used for molecular simulation, which, as a method of enabling calculation of potential values at particle positions for both non-periodic boundary conditions and periodic boundary conditions with precision by a lower amount of computation, comprises the steps of: creating grid points that are proportional to the half-value width of two-body potential function g; decomposing two-body potential function g into a composite product of two functions α aand β; assigning the scalar values that are allotted to particles to grid points using function β; and multiplying the scalar value on each grid point with function α. WO00/45334 discloses a method of calculating a three-dimensional model structure of a protein by a molecular mechanics technique.

References:

Here, the references cited in this specification are listed.

[1] U. Essmann, L. Perera, M. L. Berkowitz, T. Darden, H. Lee, and L. G. Pedersen, “A smooth particle mesh Ewald method,” J. Chem. Phys., 103(1995), 8577-8593.

[2] L. Greengard, and V. Rokhlin, “A fast algorithm for particle simulation,” J. Comput. Phys., 73(1987), 325-348.

[3] E. L. Pollock and J. Glosli, “Comments on P3M, FMM, and the Ewald method for large periodic Coulombic systems,” Comput. Phys. Comm., 95(1996), 93-110

[4] R. D. Skeel, I. Tezcan, and D. J. Hardy, “Multiple grid methods for classical molecular dynamics,” J. Comput. Chem. 23(2002), 673-684.

[5] W. Hockney, J. W. Eastwood, “Computer Simulation Using Particles,” McGraw-Hill New York, 1981

[6] P. Allen and D. J. Tildesley, “Computer Simulation of Liquids,” Oxford Univ. Press, 1987

### SUMMARY OF THE INVENTION

The present invention is constituted of the following two techniques.

(1) As already described, it has been, impossible for the method of Skeel et al. [4] to achieve high enough precision as needed in simulation. This is because the basis functions used in the method of Skeel et al. present continuity in their first derivatives or second derivatives only, but present no continuity in the higher-order derivatives. This is why error occurs in proportion to about the square of the grid width, causing poor approximation.

The key idea of the first technique of the present invention is that functions that present continuity in at least second-order or higher derivatives should be adopted as the basis functions, and when a pair of grid points (or pair of particles) in the subject level both coincide with the grid points in a coarser grid of the level one step higher, charges at the grid points of the higher level are determined so that the energy of the pair in the level one step higher necessarily becomes equal to the correct energy value of the subject level.

Upon use of this technique, there two steps to be added to the conventional calculation procedures.

One of the added steps relates to electric charge at grid points. After once electric charges have been assigned to the grid points of the level one step higher by the method of Skeel et al., a calculation step of re-assigning charges at grid points in a broader range is added. FIG. 4 illustrates this additional step in one-dimensional system, wherein a circle represents an electric charge at a grid point and its size represents the magnitude of the charge. At level 1, grid points correspond atoms. As shown in (a), when the coordinate of the grid point at the level one step below is x, the grid size of the subject level is h, and the nearest grid point to x is k, charges are assigned to the grid points (coordinate kh) near x only, as shown in (b), by the method of Skeel et al. while in the method of the present invention, charges are re-assigned to the grid points in the broader range, as shown in (c).

The second of the additional steps relates to interpolating calculation of potentials and forces. This step is a step for distributing potentials to grid points of a broader range in the subject level before interpolation of potential values to the grid points of the level one step below, by using a method that is consistent with the energy expression based on the re-assignment.

The present invention is able to keep high calculation accuracy by the addition of these two steps. (2) The second technique in the present invention is one that is based on the first technique, and relates to speedup of computation when the multigrid method is applied to an isolated system in the grid systems of different levels. In this technique, an isolated molecular system is put into every periodic box or periodically iterating unit and the boxes are arranged in a spatially periodic manner, so as to enable application of periodic boundary conditions. FIG. 5 illustrates this technique in one-dimensional system, wherein a circle represents an atom with charge or a grid point with charge. In this scheme, extra buffer areas are inserted between minimum periodic boxes that each contain an isolated molecular system so that the grid points existing in one periodic box are made apart by the kernel's influential outreach distance (i.e., shield distance) or greater from those existing in other periodic boxes. In this way, introduction of periodicity enables use of calculation using the 3D-FFT technique. No particle exists in the added buffer areas. Here, the lengths of the sides of the buffer area are determined based on the influential outreach distance and the grid size.

In order to clarify the advantages of the second technique, this method will be compared to a case with a single level. In the single level, in order to separate the periodic boxes, it is necessary to set the length of the side of the buffer area to be equal to or greater than the length of the size of the minimum box that contains an isolated system. Therefore, this method needs about twice the number of grid points compared to the multigrid method, so needs longer calculation time with a greater memory capacity. In contrast, in the case of the multigrid method, for fine grid levels the shielding radius is small hence the buffer area is also small, so that it is possible to suppress increase of the number of grid points and increase of the calculation time while for coarse grid levels, the number of grid points itself is low though large buffer areas are needed, resultantly the calculation time can be made short.

Though it is not impossible to apply this second technique to the method of Skeel et al. [4] without use of the aforementioned first technique, in such a case there is a risk that high enough precision cannot be secured. The second technique is preferably used in combination with the first technique.

According to a molecular simulation method of the present invention, a molecular simulation method including the step of calculating non-bonding interactions in a system having particles with electric charges, using a multigrid method, comprises the step of determining the electric charges at grid points in a coarser grid of a higher level that is one step higher than the level to be observed, when a pair of grid points in the observed level, or a pair of particles in the observed level, both coincide with the grid points of the grid of the higher level, so that energy of the pair in the higher level becomes equal to a correct energy value in the observed level.

Alternatively, according to a molecular simulation method of the present invention, a molecular simulation method including the step of calculating non-bonding interactions in a system having particles with electric charges, using a multigrid method, comprises: when assigning electric charges to grid points in a coarse grid of a higher level that is one step higher than the level to be observed, the step.of assigning the electric charges to neighboring grid points in the higher level, and the step of re-assigning the assigned electric charges to grid points of a broader range; and, when interpolating potential, electric field or force acting on the grid points in the observed level into neighboring grid points in a finer grid of a lower level that is one step lower than the observed level, the step of distributing the electriccharges to grid points of a broader range in the observed level, prior to the interpolation.

The above molecular simulation methods, in order to handle an isolated molecular system in each grid system of a different level as a periodic system, may includes the step of generating periodic boxes by adding extra empty buffer areas having no particle between boxes that each contain the isolated molecular system, so that the grid points existing in one periodic box are made apart by the influential outreach distance of an interaction kernel or greater from those existing in other periodic boxes. The size of the buffer area may be determined by calculating the necessary minimum size, based on the kernel's influential outreach distance and the grid size. When such periodic boxes are created, three-dimensional fast Fourier transforms can be applied to such a gird system.

According to a molecular simulation apparatus of the present invention, a molecular simulation apparatus which of calculates non-bonding interactions in a system having particles with electric charges, using a multigrid method, comprises: a memory; multigrid point constructing means for constructing multigrid points in accordance with supplied coordinates of atoms and storing them into the memory; charge calculating means which accesses the memory and assigns electric charges to grid points in a coarser grid of a higher level that is one step higher than an.observed level; and potential calculating means which accesses the memory and interpolates potential, electric field or force acting on the grid points in the observed level into neighboring grid points in a finer grid of a lower level that is one step lower than the level to be observed. In the apparatus, the charge calculating means comprises: means of assigning electric charges to the neighboring grid points of the higher level and storing the result to the memory; and means of re-assigning the assigned electric charges, grid points of a broader range by referring to the memory and storing the result to the memory. The potential calculating means distributes the electric charges to the grid points of a broader range in the observed level, prior to the interpolation.

This molecular simulation apparatus may further include buffer area setup means which, in order to handle an isolated molecular system in each grid system of a different level as a periodic system, generates periodic boxes in the multigrid system stored in the memory, by adding extra empty buffer areas having no particle between boxes that each contain the isolated molecular system, so that the grid points existing in one periodic box are made apart by the influential outreach distance of an interaction kernel or greater from those existing in other periodic boxes. The size of the buffer area may be determined by calculating the necessary minimum size, based on the kernel's influential outreach distance and the grid size.

The capability of a computer to deal with 3D-FFT calculation greatly depends on its architecture, so is greatly different between individuals. Depending on the degree of the processing capability to deal with 3D-FFT calculation, the present invention has the advantages as follows compared to the conventional methods.

When a large number of CPUs, specifically about 32 or more CPUs are used, 3D-FFT computation produces a bottleneck in parallelization of the computation in the conventional method, in consideration of the performance of PC. clusters as of present. In contrast, according to the present invention, it is possible to achieve parallelization of computation within acceptable precision level using a real-space type multigrid method free from 3D-FFT computation, or a non-FFT type multigrid method.

On the other hand, when a lower number of CPUs, specifically about 32 or less CPUs are used, it is impossible to speed. up the computation for an isolated system in the conventional method, in consideration of the performance of PC clusters as of present. In contrast, development of the present invention enables use of 3D FFT method, hence it is possible to enhance the calculation speed while keeping the allowable precision level, compared to the conventional methods.

Further, in accordance with the present invention, when a dedicated MD board is used in combination, it is possible to achieve fast computation with high precision. In the existing methods, namely the PME method and FMM, particle-particle interactions are calculated for short-range simulation while particle-mesh interactions are calculated for long-range simulation. On the other hand, the dedicated MD boards currently available are ones that perform high speed computation of particle-particle interactions only. It is difficult to develop a MD board for calculating particle-mesh interactions because such interaction is too much complicated. As a result, up to the present, however fast could particle-particle interactions be processed by a dedicated board, there would remain particle-mesh interaction part which should be handled by a general-purpose computer. Hence, there was a limit to raise the total system performance. Since, when using the present invention, the interaction through the short-range kernel between grid points is given based on the same formalism as the Coulomb interaction between particles, a currently available dedicate board can be used to perform calculation of the interactions via the short-range kernel, thus making it possible to drastically reduce the load on the general-purpose machine. Accordingly, the present invention makes it possible to achieve fast computation while keeping high enough accuracy for practical use.

The above objects, features, and advantages of the present invention will become more apparent from the following description based on the accompanying drawings which illustrate an example of preferred embodiments of the present invention.

### BRIEF DESCRIPTION OF THE DRAWINGS

FIG. 1A is a diagram showing the multiple splitting of an interaction potential (kernel) and particularly showing separation of kernel into a long-range type and a short-range type;

FIG. 1B is a diagram showing the multiple splitting of the interaction kernel along with long-range kernels;

FIG. 1C is a diagram showing the multiple splitting of the interaction kernel into multiple parts along with short-range kernels;

FIG. 2 is an diagram showing a multigrid system and short-range kernels;

FIG. 3 is a diagram showing an existing algorithm of a multigrid method;

FIG. 4 is a schematic diagram showing one-dimensional model of assignment and re-assignment of electric charges;

FIG. 5 is a schematic diagram showing one-dimensional model of buffer areas formed between isolated systems so that the isolated system can be handled as a periodic system;

FIG. 6 is a flowchart showing a process in the first embodiment of the present invention;

FIG. 7 is a flowchart showing a process as an upward path in the first embodiment;

FIG. 8A is a chart showing an example of matrix A used for charge re-assignment;

FIG. 8B is a chart showing an example of matrix A used for charge re-assignment where high-order derivatives at endpoints in grid systems are set at zero;

FIG. 8C is a chart showing an example of matrix A used for charge re-assignment where high-order derivatives at endpoints in grid systems are set at zero and the bandwidth is reduced;

FIG. 9 is a flowchart showing a process as a downward path in the first embodiment; and,

FIG. 10 is a block diagram showing one example of a molecular simulation apparatus configuration based on the present invention.

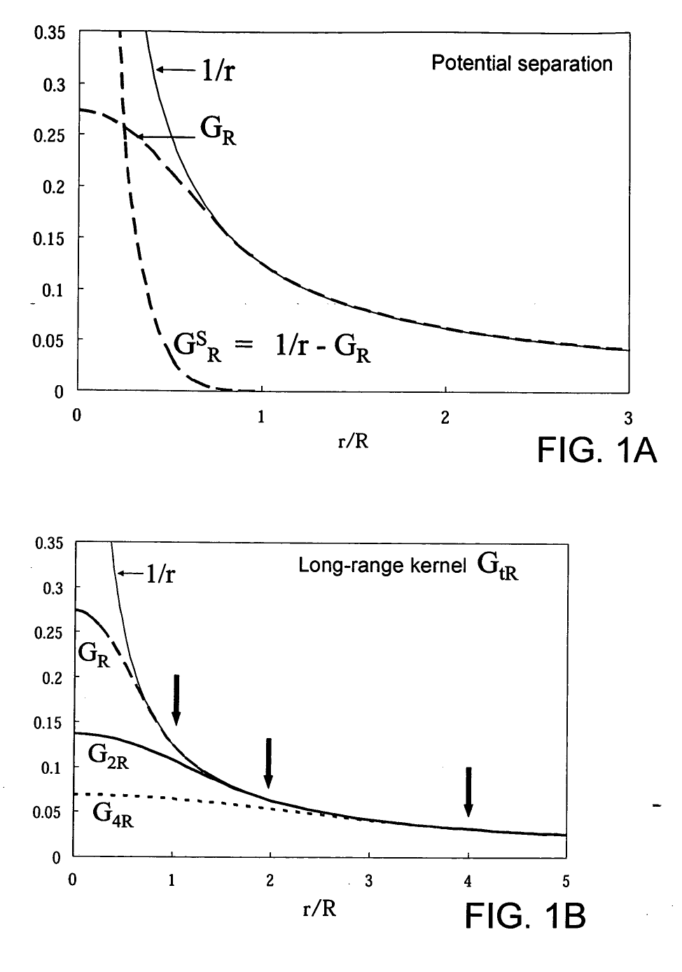

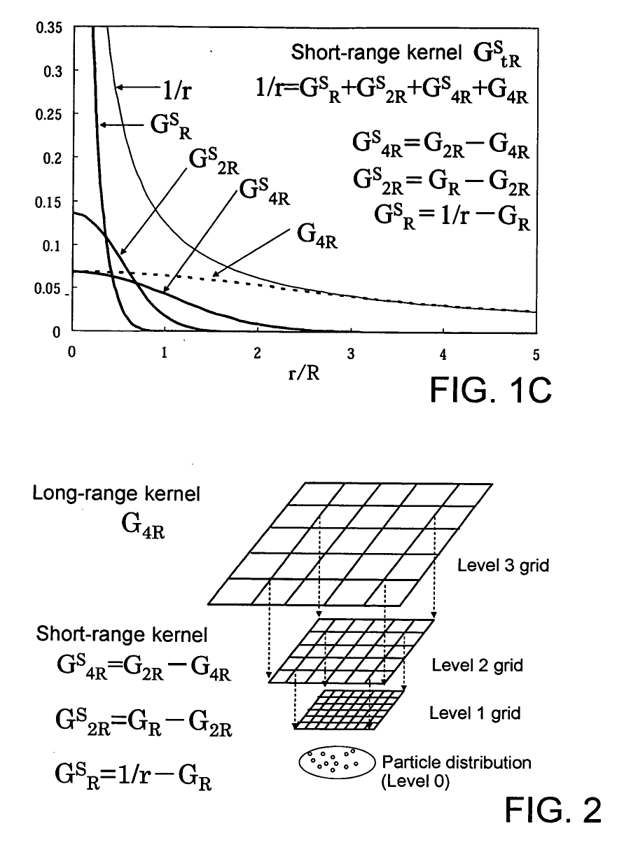

### DESCRIPTION OF THE PREFERRED EMBODIMENTS

FIRST EMBODIMENT:

Calculation of an Isolated System:

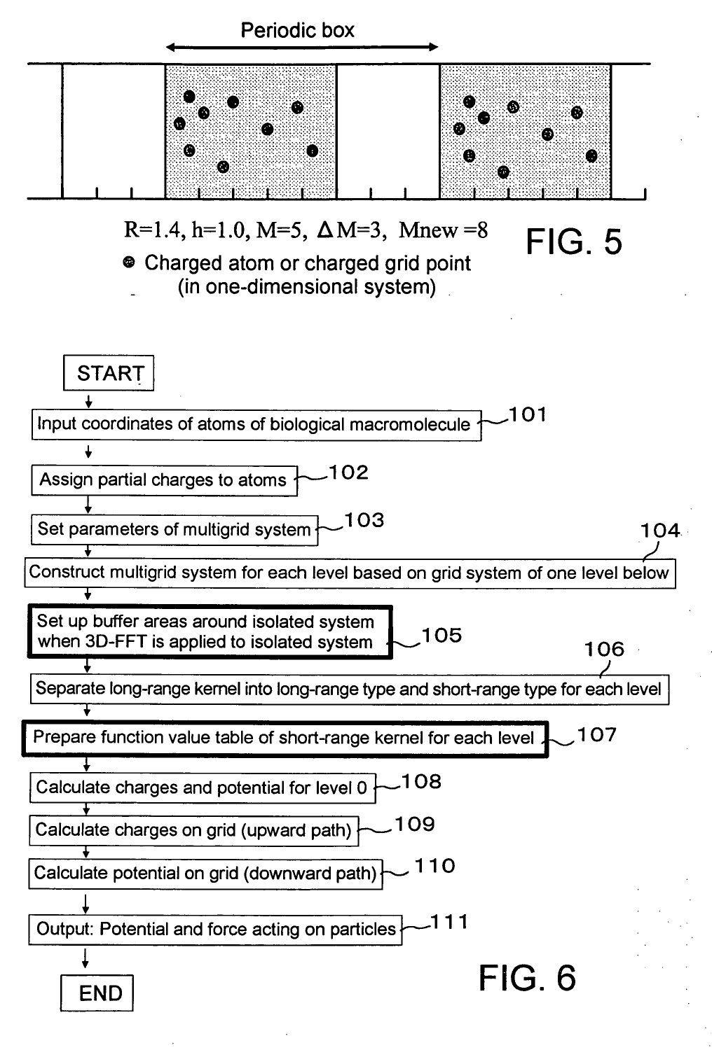

To begin with, as the first embodiment of the present invention, description will be made on an example in which the molecular simulation method according to the present invention is applied to an isolated system. FIG. 6 shows the total flow of the process in the first embodiment. Here, description will be made on a case where the method of the present invention is applied to molecular simulation of biological macromolecules such as proteins.

Procedural Steps for Constructing a Multigrid System:

First, at Step 101, coordinates of atoms of a biological macromolecule are input. Specifically, data depicting the coordinates of every atom that constitutes a target biological macromolecule and the type of the atom is input. For example, data in the PDB (Protein Data Bank) format may be input.

Next, at Step 102, a molecular computation program (MD code) such as Amber, Charmm or the like is applied to the atomic system so as to assign partial charges to all the atoms in accordance with the uneven distributions of the charges in amino acid residues.

Then, at Step 103, multigrid system parameters are set. Specifically, the outside frame of the grid that covers the atomic system is set up so as to allow for some margin, based on the maximum and minimum values of x, y and z coordinates of the atoms. Next, the value of level Lmax for the coarsest grid, and grid size h at level 0 for the finest grid, in one word, the mesh width is set.

Next, at Step 104, for the grid system of every level, the grid system is constructed based on the grid system of one level below, to thereby construct the whole multigrid system. Here, as an example of the basis function a B-spline function is used. It should be noted that level 0 corresponds to the particle system (i.e., atomic system).

As is well known, when interpolation of a given function is performed using a B-spline function there occurs in some cases that the accuracy of interpolation deteriorates at the ends of the section. To avoid this, it is possible to add extra gratings in an number of Δm when the grid system of one level higher is constructed. In a typical example, when the order of the used B-spline is P, Δm=(P/2−1), and if not added, Δm=0. The ranges of the grids can be determined according to the following equations:
(the coordinate of the lower end of level L)=(the coordinate of the lower end in level L−1)−Δm(the grid size in level L);
(the number of grid points in level L)=Round-up[(the number of grid points in level L−1)/2]+266 m;
(the grid size in level L)=(two times the grid size in level L−1)=2^{L-1}h (12)
where each grid point is represented by a set of three integers (nₓ, n_{y}, n_{z}), which respectively take values of nₓ=0, 1, 2, . . . ,Mₓ; n_{y}=0, 1, 2, . . . ,M_{y}; and n_{z}=0, 1, 2, . . . , M_{z}. The number of grid points in the above equations indicates one of Mₓ, M_{y} and M_{z}. It should be noted the number of grid points is not Mₓ+1. When the grid size differs depending on the direction of axis, the description will make sense if the wording is changed as appropriate In a specific example, the value of the order P is an even number equal to or greater than 4, typically P=4 to 20.

In the process of molecular simulation over steps of some ten thousands hours, renewal of the grid system is preferably done when the maximum value of the displacement of the atom position from the previous renewal exceeds a “threshold value” set as large as 0.01 nm to 0.1 nm.

The Procedural Steps of Applying 3D-FFT to an Isolated System:

Next, at Step 105, when 3D-FFT (three-dimensional fast Fourier transform) is applied to an isolated system, buffer areas are set up around the isolated system to be studied. The step for setting up buffer areas is one of distinctive characteristics of the present invention.

It is considered that FFT that is often used for periodic systems cannot be applied to isolated systems because an isolated system is not periodic. However, a manipulation described below makes application of FFT to an isolated system possible.

It is assumed that an isolated system is contained in a box and a grid system of level 1 is formed in the box. When the grid size at level 1 is represented by h, it holds that the grid size=2^{L-1}h and the cutoff distance (i.e., potential range)=2^{L}R for the grid system at level L, respectively. Accordingly, if ΔM pieces of empty cells, i.e., cells without any charged particle, are added extra in the coordinate axis direction so as to provide buffer areas, and when the minimum value of ΔM which satisfies the. relation 2^{L-1}h ΔM>2^{L}R or,
ΔM>2R/h (13)
is selected to thereby enlarge the box, the neighboring boxes cannot be seen constantly in the grid system of level L. Hence it is possible to handle the isolated system as a periodic system and apply the FFT technique to the system.

As described above, FIG. 5 illustrates addition of buffer areas to one-dimensional system at level 1. In a case where short-range kernel outreach distance parameter R=1.4 and grid size h=1.0, the molecular system is covered by a grid with its total grid cell number M=5. As three empty cells with no charged particle, ΔM=3, are added around it, the total number of cells corresponding to the periodic box is increased to M=8, as shown in FIG. 5. Since the outreach of the short-range kernel at level 1 is at most 2R=2.8, no interaction with the adjacent boxes will occur. If the grid size differs depending on the direction of the axis, ΔM that is different for one axis from that of another may be used.

When a grid system is made up of M×M×M grid points, the number of its interaction pairs is of the order of M⁶, so that the computational complexity is represented as O(M⁶) or proportional to M⁶. On the other hand, use of 3D-FFT method makes it possible to reduce the computational complexity to the order of M³ logM, or O(M³ logM). Accordingly, this method is especially effective in a computer having an architecture that enables high-speed computation of 3D-FFT.

Conventionally there has been proposals which intend to create a periodic boundary condition by periodically arranging isolated molecules in the space. In this case, however, it is necessary to take intervals greater than the size of the molecule between the periodically arranged molecules, so that there occurs the problem that the total space to be studied becomes large and the points of FFT calculation reaches an enormous number. In the case of the present embodiment, the outreach of the kernel is much smaller than the size of the molecule, so that it is possible to arrange the molecules densely enough in the periodic arrangement compared to the method proposed conventionally. As a result, it is possible to drastically reduce the number of the points of FFT calculation, hence complete the computation in a short period of time.

Kernel Separation:

Next, at Step 106, in each level, the kernel is separated into the long-range type and the short-range type.

Preparation of a Function Value Table:

Since it takes time to calculate kernel function values, it is preferable that a function table of short-range kernels is prepared beforehand at Step S107. This step for preparing a function value table of short-range kernels is one of distinctive characteristics of the present invention. In this embodiment, for preparation of a function value table, the function determined in the following manner is adopted.

Charge density ρ(r) in conformity with the following equation is distributed inside a sphere with radius R:
ρ(r)=const[(1−r/R)(1+r/R)]^{d-2} (14),
where “const” is a normalization constant and is determined so that the total amount of charge in the sphere is equal to 1. The charge density becomes weaker and smoothly reduces to zero as it approaches the surface of the sphere. In electrostatic potential Φ(r) in this case can be obtained analytically as a solution of the following Poisson equation:
∇²Φ(r)=−4πρ(r) (15).
Since a point charge, concentrated at the origin is replaced by a smooth distribution of a charge around the origin, the electrostatic potential obtained as the solution of Eq. (15) coincides with 1/r in the remote area away by distance R or greater from the origin, but has finite values without divergence as it close to the origin. Accordingly, this solution has properties suitable as long-range kernel G_{R}(r). The important feature as to the smoothness of the function is that G_{R}(r) is continuously differentiable with d times at r=R since the charge distribution is continuously (d−2)-times differentiable. Since the upper limit of interpolation error with a spline function is determined by the P-th order differential coefficient of G^{S}_{R}(r) when the order of the spline function is assumed to be P, it is important that the spline's order P and the d herein are made consistent in order to maintain the accuracy with least costs.

Other than the above, it is possible to perform separation using various functions listed hereinbelow:

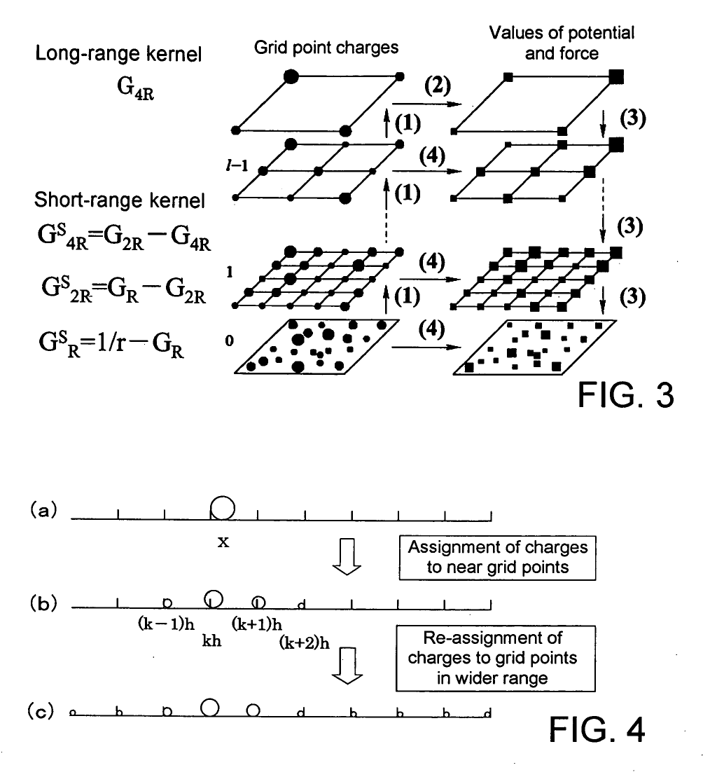

(1) The function described in Skeel et al. [4] (where a in FIG. 3 in [4] corresponds to R in Eq. (2) of this specification),

(2) The function defined in Hockney et al. [5] (where a in Eq. (8-75) in [5] corresponds to R in Eq. (2) of this specification),

(3) An error function-type function (e.g., Ewald sum shown in Allen et al. [6]):
G_{R}(r)=[1−erfc(αr)]/r, G_{R}(0)=2α/π^{1/2}, G^{S}_{R}(r)=erfc(αr)/r (16),
where “erfc” is a complementary error function. When correspondence is taken so that 1/α=3R, G^{S}_{R}(r) is substantially (though not perfectly) zero when r>R.

Calculation of the Potential and Force Acting on Particles:

As the function value table of short-range kernels has been prepared, calculation of the potential and forces acting on particles is started. Herein, the potential exerted on atom j of the observed level by other atoms through short-range kernel will be calculated in accordance with the following equation.
φ^{S}(rᵢ)=Σⱼqⱼ G^{S}_{R}(rᵢ−rⱼ) (17),
where qⱼ is the electric charge on atom j. This is the very ordinary particle-particle interaction.

To begin with, at Step 108, for level 0 (particle system) the potential and force acting on the particles are calculated based on the short-range kernel. This corresponds to the calculation of the horizontal path designated by (4) in FIG. 3 described above.

Calculation of the Upward Path (Successively Increasing the Grid Level L from 1 to Lmax):

<Start of calculation of the upward path>

Next, at Step 109, in order to calculate the charges on the grid, calculation of the upward path described with FIG. 3 is started. Along this path, electric charges at grid points are determined successively.

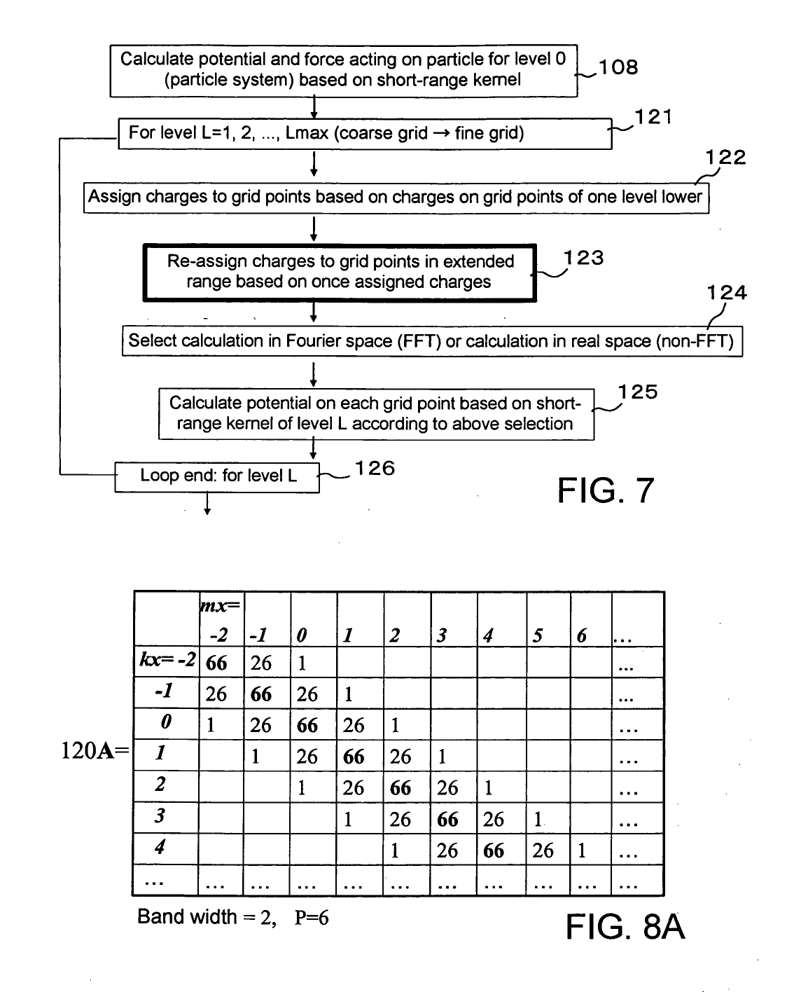

FIG. 7 shows a flowchart for calculation of the upward path. As shown, the calculation of the upward path can be briefly described as follows. After calculation of the potential and force acting on the particles based on the short-range kernel for level 0 at Step 108 described above, at Step 121, a loop is started by increasing level L one by one from level 1 to Lmax. In this loop, first at Step 122, electric charges are assigned to the grid points of the current step level, based on the grid points of one level lower. At Step 123, based on the once assigned charges electric charges are assigned again to grid points in the extended range. Then, at Step 124, it is selected whether calculation should be made in the Fourier space (FFT) or in the real space (non-FFT). At Step 125, the potential at each grid point is calculated in the selected space, based on the short-range kernel at the current level L. Then, at Step 126, the operation reaches the end point of the loop that has-started at Step 121. If the termination condition of the loop is not satisfied, the operation returns from Step 126 to Step 121.

The step for re-assignment at Step 123 is one of the distinctive characteristics of the present invention. Step 122 corresponds to the calculation of the upward path designated at (1) in FIG. 3 described above. Step 125 corresponds to the calculation of the horizontal path designated at (4) in FIG. 3.

Next, calculation of the upward path will be described referring to a case of the grid system at current level L=1.

In this case, the lower level 0 is the particle system, and t=2^{L} is equal to 2. It can be considered that the energy in the particle system can be approximated with precision by the grid system if the electric charges at the grid points are determined so that the energy in the grid system coincides with the correct energy when the particles occupy the grid points.

First, the mathematical background will be described. Kernel G^{S}_{R}(rᵢ−rⱼ) is subjected to double expansion with basis function W, regarding it as a function of rᵢ and rⱼ. When the expansion coefficients are determined under the condition that if both rᵢ and rⱼ coincide with grid points, the expansion result coincides with the original function value, in other words, the condition that the expansion result coincides with the correct energy value for the two particle system, the following approximate expansion expression (interpolation expression) can be obtained.
G^{S}_{tR}(rᵢ−rⱼ)=Σ_{kΣ}ₘW(rⱼ−nₖ) W(rⱼ−nₘ) Σ_{k′Σ}_{m′}(A⁻¹)_{kk′}(A⁻¹)_{mm′}G^{S}_{tR}(n_{k′}−n_{m′}) (18)

The expansion error when a B-spline is used as basis function W is of the order of the product of the upper limit of the absolute value of the P-th order derivative of G^{S}_{tR} and h^{p}, so that the interpolation expression will provide high accuracy. As this approximate expansion expression is substituted into the following energy expression:
U^{S}_{R}=(½)Σ_{i Σ}ⱼqᵢ qⱼ G^{S}_{tR}(rᵢ−rⱼ) (particle system) (19),
an energy expression for the grid system:
U^{S}_{tR}=(½)Σ_{k,i}q′ₖq′ᵢG^{S}_{tR}(nₖ−nᵢ) (grid system) (20),
can be obtained. Charge q′ₖ on each grid point contained in this expression can be calculated by the following procedure.

<Step for charge assignment>

Charges are assigned with weighs W(rⱼ₋ₙₖ) to the grid points in the vicinity of a charged particle as shown in FIG. 4(b):
q″k=Σⱼqⱼ W(rⱼ−nₖ) (21).

In this equation, nₖ is a position vector of grid point k, and the summation over particles j may and should be taken for the particles with W(rⱼ₋ₙₖ) being non-zero. These particles j are located in the vicinity of grid point k. Since the conventional multigrid method proposed by Skeel et al. [4] includes this assignment step only but does not include the following step for charge re-assignment, the method results in low precision.

The W function herein is a product of ordinary B-spline functions, and can be represented in a decoupled form with x, y and z components:
W(rⱼ−nₖ)=B((rⱼₓ−nₖₓ)/h)B((r_{jy}−n_{ky})/h) x B((r_{jz}−n_{kz})/h) (22).

The definition and properties of B-spline functions are illustrated in many textbooks; of these, the important features in the following description are that a P-th order B-spline function B(x) is a piecewise (P−1)-th polynomial in an interval (−P/₂, +P/2) and takes zero outside the interval. Accordingly, for the summation over particles j, for example, with respect to the x-component, it is sufficient enough if particles j which are located in the vicinity of grid point k and whose |rⱼₓ−nₖₓ|/h is equal to or less than P/2 are taken.

<Step for charge re-assignment>

As shown in FIG. 4(c), electric charges are assigned again to grid points in a broader range in accordance with the following equation, as shown in FIG. 4(c):
q′ₗ=Σₖq″ₖ(A⁻¹)ₖₗ (23),
where A is a matrix defined by the following equation, that is, an inverse matrix of weight matrix W:
Aₖᵢ=W(nₖ−nₗ) (24).

As understood from the above equations, the charge values at grid points are independent on the specific kernel function.

Since function W is decoupled into x, y and z components, both matrix A and the inverse matrix of A are also decoupled into x, y and z components, so that it can be written as A⁻¹=Ax⁻¹ Ay⁻¹ Az⁻¹. Accordingly, when grid point k is explicitly written as (kx, ky, kz), the summation of the above equation over k can be obtained by taking summations of three components in turn:
q′_{lx,ly,lz}=Σ_{kz}{Σ_{ky}[Σₖₓq″_{kx,ky,kz}(Ax⁻¹) _{kx,lx}](Ay⁻¹)_{ky,ly}}(AZ⁻¹)_{kz,lz} (25).

W(nₖ−nₗ) takes a non-zero value only when the two grid points are located spatially close to each other, and the degree of closeness is determined depending on the order of P of the spline. Therefore, matrix A and also its x, y and z components, in effect, constitute band matrixes, and they can be solved by the standard solving method for band matrix type simultaneous equations. Renewal of the aforementioned matrix A and its inverse matrix may be done enough when the. grid system is reconstructed.

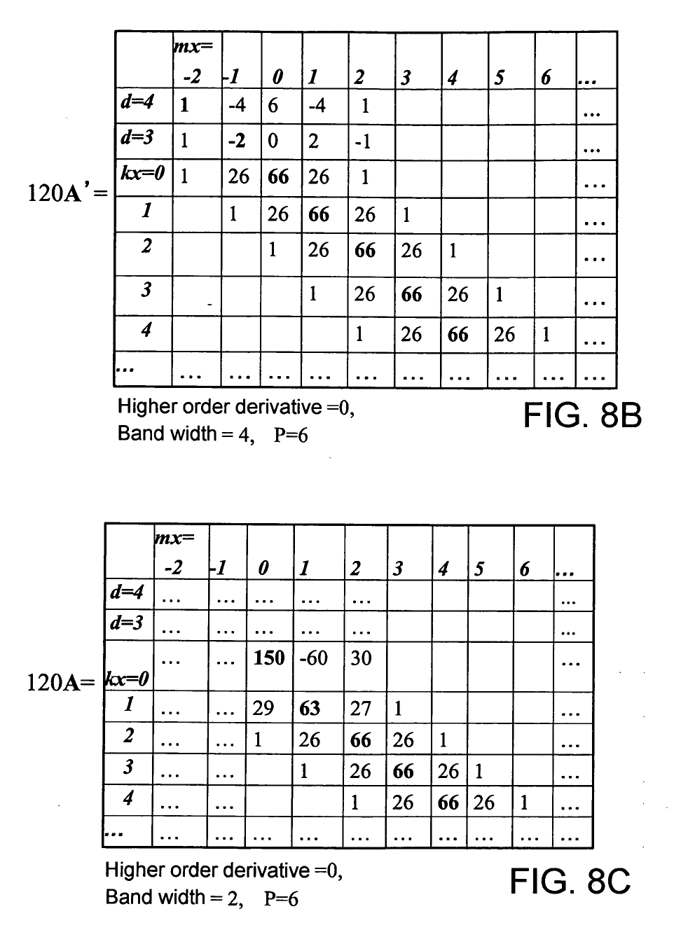

FIG. 8A illustrates an example of matrixes Ax, Ay and Az for the spline's order P=6. Here, the extra added grid points are kx=−2, −1. The elements of matrix A at the endpoints of the grid are given in the point symmetrical form of the values at the start points.

The above description was made where the level being processed is L=1. For a higher level, the description will make sense if the wording “particles” is replaced by “grid points at the fine level one step lower” and “grid points” is replaced by “grid points at the level being processed”.

<The altered points when an interpolating method with higher order derivative values set at zeros is adopted>

In the case where a boundary condition that specifies the higher differential coefficients at an endpoint to be zero, the expression of matrix A will be changed at its end points. In this case, though some complexity is added to its process, there are some advantages for precision improvement and improvement in calculation processing speed accompanied by reduction in matrix size.

The altered point will be described below. It is assumed that in constructing a grid system extra grid points in a number of Δm=(P/2−1) are added to both ends of the interval. Here, the grid points that have existed before Δm grid points are added at both ends are indicated by k and m, and of these the grid points that were previously located at both ends are particularly indicated by e (indicating “ends”) while the Δm grid points added at both ends are indicated by a (indicating “additional”). Further, a condition that, of the interpolated values of higher-order derivatives of kernel at ends, the derivatives of their differentiation order d ranging from P/2-th order to (P−2)-th order are set at zero is added.

When the. condition is added, it becomes. necessary to perform calculation of an inverse matrix of coefficient matrix A′ of the simultaneous equations that determine charges at all the grid points inclusive of the added grid points (i.e., a), instead of A given by Eq. (24).

$${A}^{′} = ( \begin{matrix}ɛ & γ \\ β & α\end{matrix} ) \qquad ( 26 )$$

where the elements of α, β, γ and ε are given by the following equations:
αₖₘ=W(nₖ−nₘ),
βₖₐ=W(nₖ−nₐ),
γμₖ=W^{(d)}(nₑ−nₖ),
εμₐ=W^{(d)}(nₑ−nₐ) (27),
where μ denotes a pair of e and d by one character. The bandwidth of this matrix A′ in its interior is P/2−1 while it is greater, specifically P−2, at the end. For example, FIG. 8B shows an example of x-elements of matrix A′, and the bandwidth in the row with d=4 (e=starting end) becomes greater, specifically, 4, which causes the problem that numerical calculation takes longer time.

However, since it is possible to analytically solve part of the simultaneous equations in Eq. (27) so that the components other than km components can be eliminated from A′, it is possible to show that matrix A defined in the following equation can be used for the charges at the added grid points at both ends (i.e., a):
A=α+βε⁻¹γ (28).

For this A, the bandwidth is limited to P/2−1, providing preferable result. When. this A is used, the added 2 Δm grid points become non-entity just supplementarily introduced for formalism purposes, hence it is not necessary to assign charge in effect and also it is possible to exclude them for summation over the grid points. FIG. 8C shows an example of x-elements in this matrix A.

<Calculation of the potential at a grid point (corresponding to the horizontal path)>

The potential of a grid point of the level being processed, exerted by other grid points via a short-range kernel is calculated by selecting the method based on the real space or the method based on the Fourier space.

(1) In the case of the real space method (without 3D-FFT):

Calculation is carried out in accordance with the following equation:
φ^{S}(nₖ)=Σₘq′ₘG^{S}_{tR}(nₖ−nₘ) (29),
where q′ₘ is the charge at grid point m. Since the influential outreach of the kernel is at most tR, the summation over m is sufficient enough if the grid points located within the distance tR from grid point k are considered (t=2^{L}).

(2) In the case of the Fourier space method (with 3D-FFT):

As is well known (Allen et al. [5], for example), the energy, potential and electric field of a system in which grid systems are periodically arranged can be calculated at high speed using 3D-FFTs in accordance with the following scheme: 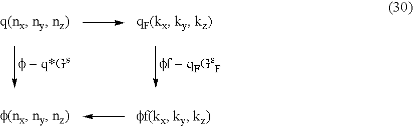
where subscript F indicates Fourier transformed quantity and * indicates convolution product. G^{S}_{F}(kₓ, k_{y}, k_{z}) is the finite Fourier transform of G^{S}(nₓ, n_{y}, n_{z}) where the variability domain of integer nₓ upon transformation is not 0 to Mₓ but is extended from−∞to +∞. However, G^{S}(nₓ, n_{y}, n_{z}) takes non-zero values only when n =|n|<2^{L}R holds, so the summation is sufficient enough if it is taken-in the finite range.

With the above process, calculation of the horizontal path is completed.

Calculation of the Downward Path (with Grid Level L Successively Reduced from Lmax-1 to 0):

<Start of calculation of the downward path>

Next, at Step 110 in FIG. 6, in order to successively determine the potential, electric field and force at every grid point, calculation of the downward path described with FIG. 3 is started.

The energy expression obtained by the aforementioned re-assignment of charges does not give exact values but only gives approximation. However, as the electrostatic potential and force, the calculation formulae obtained by differentiating the approximate energy expression with respect to particle coordinates will always be used. In this sense, the thus calculation formulae will be called the electrostatic potential and force consistent with the re-assignment of charges. In the following description, based on these calculation formulae, the potential values at grid points of the level being processed will be calculated from the potential values obtained in the coarser grid one level above.

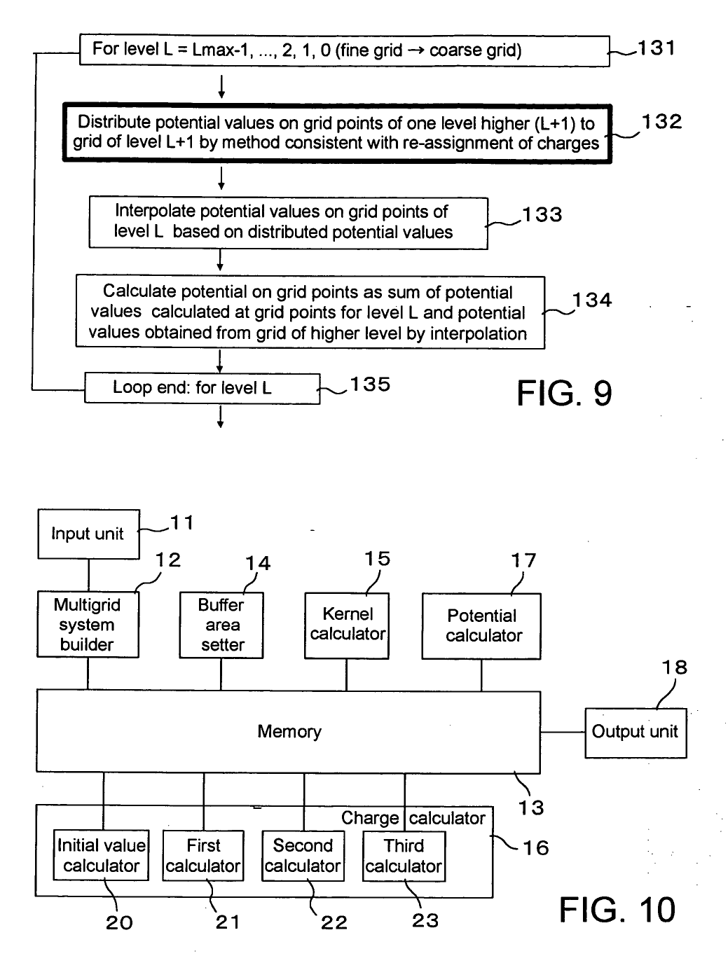

FIG. 9 is a flowchart of calculation of the downward path. As shown herein, the calculation of the downward path can be briefly described as follows. At Step 131, a loop is started by decreasing level L one by one from level Lmax to 0. In this loop, first at Step 132, the potential values at the grid points in the level (L+1) one step higher are distributed to the grid of level (L+1) by the method consistent.with the re-assignment of charges, and based on the thus distributed potential values, the potential values at the grid points of level L are determined by interpolation at Step 133. Then, at Step 134, the potential values calculated at the. grid points for level L and. the potential values obtained from the grid of the higher level by interpolation are added up to calculate the potentials at the grid points, and at Step 135, the operation reaches the end point of the loop that has started at Step 131. If the termination condition of the condition does is not satisfied, the operation returns from Step 135 to Step 131.

The step of distributing the potential values at Step 132 is one of the distinctive characteristics of the present invention. Step 133 corresponds to the calculation of the downward path designated at (3) in FIG. 3 described above. Step 134 corresponds to the summation of the calculated value of the downward path designated at (3) and the calculated value of the horizontal path designated at (4) in FIG. 3.

Next, calculation of the downward path will be described in detail.

<Step for potential distribution>

This step is derived as a result of re-assignment of charges in the upward path. Here, in the grid system of the level one step above the level L, or in the coarse grid system of the parent level, the potentials at grid points are distributed to the other grid points in accordance with the following equation:
φ″^{S}(nₘ)=Σₖ(A⁻¹)_{mk φ}^{S}(nₖ) (31).

The method of Skeel et al. [4] does not include this step, and is equivalent to the following process when φ″ is replaced by φ(φ″=φ) in the following equations.

<Step for potential interpolation>

Based on the distributed potential values φ″, potential φ^{S} at grid point i (or particle i) of the observed level L is interpolated using the following equation:
φ^{S}(rᵢ)=ΣₘW(rᵢ−nₘ)φ″^{S}(nₘ) (32).

If necessary, electric field E^{S} and force F^{S} are also interpolated in the same manner using the distributed potential values. Here, electric field E^{S} and force F^{S} are both vector quantities:
E^{S}(rᵢ)=−Σₘ ∇W(rᵢ−nₘ)φ″^{S}(nₘ) (33)
F^{S}ᵢ=qᵢE^{S}(rᵢ) (34),
where rᵢ is the position vector of particle i, nₘ is the position vector of grid point m, and ∇ represents the derivative with respect to the position vector. For calculation of ∇W, when W is of a P-th order B-spline function, its derivative can be simply given by two (P-1)-th order B-splines, so that calculation can be simply carried out.

<Step for calculation of the sum of potentials>

The potential value obtained by distribution and interpolation based on the grid of the higher level and the potential value obtained via the short-range kernel between grid points for the observed level are added up, specifically,
(the potential derived from the levels including and above the observed level)=(the potential derived from the levels equal to or above the parent level) +(the potential derived from the observed level) (35)
is calculated.

With this operation, the calculation of the downward path is completed.

Result Output:

Then, at Step 111 in FIG. 6, the potential and force acting on each particle (atom), determined by calculation of the downward path are output, thus completing the calculation of non-bonding interactions.

Calculation Example:

Next, a practical calculation example based on the algorithm of the present embodiment will be explained.

In this algorithm, the computation time and accuracy are controlled by the finest mesh size (h), shielding distance R when the potential is separated into the direct calculation component and the mesh. calculation component, spline order P, participarticles. Table 1 shows an example when applied to a system made up of about 50 thousands atoms with P=6. In this case, simulations of non-bonding interactions in a system consisting of a protein called amylomitase and water around it were carried out. The CPU used for simulation was Pentium^{(R)} 4 (operation clock frequency=2 GHz). Also direct calculation was made using the same parameters without use of the method of the present invention. The calculation took 700 seconds for the direct calculation.

TABLE 1

| | | CPU | | |
|---|---|---|---|---|
| | | Time | Relative force | Relative total |
| h | R | (sec.) | error | energy error |
| 1.0 | 10.0 | 9.37 | 3.7 × 10⁻⁶ | 6.4 × 10⁻¹⁰ |
| 1.0 | 8.0 | 7.60 | 1.4 × 10⁻⁵ | 2.2 × 10⁻⁸ |
| 1.0 | 6.0 | 6.30 | 8.4 × 10⁻⁵ | 5.0 × 10⁻⁷ |
| 1.5 | 10.0 | 5.95 | 2.2 × 10⁻⁵ | 1.1 × 10⁻⁷ |
| 1.5 | 8.0 | 4.32 | 8.7 × 10⁻⁵ | 2.8 × 10⁻⁷ |
| 1.5 | 6.0 | 3.35 | 5.3 × 10⁻⁴ | 3.4 × 10⁻⁵ |
| 2.0 | 6.0 | 2.72 | 1.2 × 10⁻³ | 3.0 × 10⁻⁵ |

For comparison, the calculation result [4] of Skeel et al. for the system of similar size is cited. Their result with the best accuracy presented a relative force error of 0.002, and the result of the present invention was three orders of magnitude better in precision than the result of Sleek et al.

Molecular Simulation Apparatus:

Next, a molecular:simulation apparatus for calculating non-bonding interactions based on the above-described procedures will be described. FIG. 10 shows. a molecular simulation apparatus for this purpose.

The molecular simulation apparatus comprises input unit 11, multigrid system builder 12, memory 13, buffer area setter 14, kernel calculator 15, charge calculator 16, potential calculator 17 and output unit 18. Coordinate values of the atoms of a molecule to be examined and the necessary parameters are supplied to input unit 11. Multigrid system builder 12 executes the aforementioned operations at Steps 102 to 104 so as to add partial charges to the atoms and set the parameters in the multigrid system, thereby construct the aforementioned multigrid system. The thus built multigrid system is stored into memory 13. Memory 13 functions as a work memory when non-bonding interactions are calculated, and also stores information as to charge, electric field, potential, force, etc. for every grid point in the multigrid system. Buffer area setter 14 executes the aforementioned operation at Step 105 for the multigrid system stored in memory 13 so as to set up buffer areas around the—system, if necessary. Kernel calculator 15 executes separation of kernels at Step 106 and the operation of preparing the function value table at Step 107. The thus prepared function value table is also stored into memory 13.

Charge calculator 16 accesses memory 13 and calculates the potential and force in level 0 at Step 108, and performs calculation of the upward path at Step 109. This charge calculator 16 includes: initial value calculator 20 for calculating potential and force in level 0; first calculator 21 for calculating every matrix element Aₖₗ=W(nₖ−nₗ) for adjacent grid point pair nₖ and nₗ and basis function W, in advance and storing non-zero elements of the obtained band matrix A into memory 13; second calculator 22 for calculating simply assigned charge q″ₖ at each grid point by multiplying the charge of each particle qⱼ by weight W (rⱼ−nₖ) and assigning charges to grid points nₖ near the particle and stores the calculated result into memory 13; and third calculator 23 for determining charge q′ₘ to be re-assigned to eachgrid point by solving simultaneous equations ΣₘAₖₘq′ₘ=q″ₖ for simply assigned charge q″ₖ stored in memory 13. First calculator 21 performs calculation corresponding to Eq. (24) or Eq. (28), second calculator 22 performs calculation corresponding to Eq. (21), and third calculator 23 performs calculation corresponding to Eq. (23).

Potential calculator 17 accesses memory 13 and performs calculation of the downward path at Step 110.

Output unit 18, after completion of calculation of the downward path, accesses memory 13 to retrieve the calculation result stored in memory 13, i.e., the potential and force acting on each particle (or atom) and outputs them to the outside.

SECOND EMBODIMENT:

Calculation in a Periodic System:

Next, the second embodiment of the present invention will be described. Herein, description will be made on a calculation method suitable for the execution with a dedicated MD board by calculating interactions between grids of the same level, without using FFT while using a periodic boundary condition.

Similarly to the case of the first embodiment, coordinates of atoms of a molecule to be studied are input and partial charge is added to each atom, and the parameters in the multigrid system are set. Then, a multigrid system is constructed.

Structuring Method of a Multigrid System for a Periodic System:

In a case of a periodic system to be handled in the present embodiment, there is no need to add any extra grid. That is, it is not necessary to introduce any buffer area. However, when the maximum value of the used grid levels is represented by Lmax, it is necessary to hold the relation, (the number of grid points in level 0)=(an integer times of 2^{Lmax}) in order that the grid systems of all the levels up to Lmax will snugly match a periodic unit box. Also herein, the number of grid points;indicates any of Mₓ, M_{y} and M_{z}.

Calculation of Interactions:

After construction of the multigrid system, each interaction is calculated. In the conventional PME method and FMM method, dedicated hardware is used to handle calculation of particle-to-particle interactions only while processing of the other part by the dedicated hardware has not yet been realized since the algorithm is too complex. According to the present embodiment, a dedicated MD calculation board (dedicated hardware) can also be used to calculate grid-to-grid interactions, which provides significant effect in view of calculation acceleration. In this case, high-accuracy calculation can be obtained and this is attributed to manipulation for beneficial determination of the charges at grid points by re-assignment.

Briefly describing, a dedicated board is a processing device which holds a previously prepared function table of (dG^{S}_{tR}/dr)/r, loads first the coordinate values and charges of a few i particles as core particles into its processor, then successively reads the data of many other particles (i particles), and calculates the potentials and forces acting on individual atoms i parallel and stores them.

Since there are a multiple number of grid levels in the multigrid method, it is necessary to prepare a function table for each level even when a dedicated board is used.

When the dedicate board has a function of calculating potential φ (nₖ) exerted on each atom, it is possible to directly calculate the potential, electric field and force acting on the atom, using the interpolation method described above in the first embodiment. However, the dedicated boards available at present have no circuit for calculating potentials φ (nₖ) exerted on individual atoms, so it is impossible to directly apply them to the multigrid method. As the countermeasure against such a Gase, calculation of the electric field without use of potential values as follows can be considered:

(1) The list of the coordinates and charge (xyzq) of every particle is stored in the coordinate memory, and this list is duplexed, so that the front half of the coordinate memory is adapted to store the list with true charges while all the data of charge is set at 1 in the rear half;

(2) Upon calculation of interactions, data of core particle i is read from the rear half of the coordinate memory and another particle j as a partner is read from the front half of the coordinate memory;

3) The electric field acting on core particle i is calculated. In this case, though what is actually calculated is the force, it is equivalent to the electric field since it is assumed that qᵢ=1.;

(4) The differentiation/interpolation type interpolating method described hereinbelow is used to calculate the electric field and force acting on each particle.

Differentiation/interpolation Type Interpolating Method:

The above-described interpolating method in the first embodiment is performed by interpolation and differentiation in the sequential order. In contrast, what is described herein is a differentiation/interpolation process in which differentiation and interpolation are successively done in the order.

Using a dedicated board, electric field E^{S}(nₖ) (vector quantity) that acts on every grid point nₖ of the coarser grid one level above is calculated:

E^{S}(nₖ)=−Σₘq′ₘ ∇G^{S} (nₖ−nₘ) (36),

where q′ₘ represents the charge at grid point m.

Then, a general-purpose computer is used to distribute the values of the electric field to the other grid points in the higher grid one level above. That is, the equation as follows is calculated:
E″^{S}(nₘ)=Σₖ(A⁻¹)ₘₖE^{S}(nₖ) (37).
Using the general-purpose computer, the electric field values thus distributed in the higher grid one level above are used to perform interpolation at grid point i (or particle i) in the level being processed. Specifically, the following equations are effected.
E^{S}(rᵢ)=ΣₘW(rᵢ−nₘ)E″^{S}(nₘ) (38),
F^{S}ᵢ=qᵢE^{S}(rᵢ) (39).

In this way, it is possible to determine the electric field at a grid point or acting on a particle in a periodic system, without using FFT.

It should be noted that this differentiation/interpolation type interpolating method has the problem that the exact “total energy expression” corresponding to the above formula of the force is unclear (it is impossible to write down an analytical equation), and that the energy conservation during MD calculation may degrade in some degree, but this does not cause any practical problem.

Generally, the calculation of non-bonding interactions in each of the above embodiments is executed by installing a program therefor into a computer and running the program. Accordingly, the scope of the present invention also includes such a program for effecting the aforementioned calculation of non-bonding interactions as well as a recording medium that has such a program stored therein.

What is claims is:

1. A molecular simulation method including the step of calculating non-bonding interactions in a system having particles with electric charges, using a multigrid method, comprising the step of:
determining the electric charges at grid points in a coarser grid of a higher level that is one step higher than the level to be observed, when a pair of grid points in the observed level, or a pair of particles in the observed level, both coincide with the grid points of the grid of the higher level, so that energy of the pair in the higher level becomes equal to a correct energy value in the observed level.

2. A molecular simulation method including the step of calculating non-bonding interactions in a system having particles with electric charges, using a multigrid method, comprising:
when assigning electric charges to grid points in a coarse grid of a higher level that is one step higher than the level to be observed,
the step of assigning the electric charges to neighboring grid points in the higher level, and the step of re-assigning the assigned electric charges to grid points of a broader range; and,
when interpolating potential, electric field or force acting on the grid points in the observed level into neighboring grid points in a finer grid of a lower level that is one step lower than the observed level,
the step of distributing the electric charges to grid points of a broader range in the observed level, prior to the interpolation.

3. The molecular simulation method according to claim 1, further comprising:
in order to handle an isolated molecular system in each grid system of a different level as a periodic system,
the step of generating periodic boxes by adding extra empty buffer areas having no particle between boxes that each contain the isolated molecular system, so that the grid points existing in one periodic box are made apart by an influential outreach distance of an interaction kernel or greater from those existing in other periodic boxes.

4. The molecular simulation method according to claim 3, wherein a size of the buffer area is determined by calculating a necessary minimum size, based on the kernel's influential outreach distance and the grid size.

5. The molecular simulation method according to claim 3, further comprising the step of applying three-dimensional fast Fourier transforms over the gird system having the periodic boxes formed therein.

6. The molecular simulation method according to claim 2, further comprising:
in order to handle an isolated molecular system in each grid system of a different level as a periodic system,
the step of generating periodic boxes by adding extra empty buffer areas having no particle between boxes that each contain the isolated molecular system, so that the grid points existing in one periodic box are made apart by an influential outreach distance of an interaction kernel or greater from those existing in other periodic boxes.

7. The molecular simulation method according to claim 6, wherein a size of the buffer area is determined by calculating a necessary minimum size, based on the kernel's influential outreach distance and the grid size.

8. The molecular simulation method according to claim 6, further comprising the step of applying three-dimensional fast Fourier transforms over the gird system having the periodic boxes formed therein.

9. A molecular simulation apparatus which calculates non-bonding interactions in a system having particles with electric charges, using a multigrid method, comprising:
a memory;
multigrid point constructing means for constructing multigrid points in accordance with supplied coordinates of atoms and storing them into the memory;
charge calculating means which accesses the memory and assigns electric charges to grid points in a coarser grid of a higher level that is one step higher than an observed level; and
potential calculating means which accesses the memory and interpolates potential, electric field or force acting on the grid points in the observed level into neighboring grid points in a finer grid of a lower level that is one step lower than the level to be observed,
the charge calculating means comprising means of assigning electric charges to the neighboring grid points of the higher level and storing the result to the memory, and means of re-assigning the assigned electric charges to grid points of a broader range by referring to the memory and storing the result to the memory; and
the potential calculating means distributing the electric charges to the grid points of a broader range in the observed level, prior to the interpolation.

10. The molecular simulation apparatus according to claim 9, further comprising:
buffer area setup means which, in order to handle an isolated molecular system in each grid system of a different level as a periodic system, generates periodic boxes in the multigrid system stored in the memory, by adding extra empty buffer areas having no particle between boxes that each contain the isolated molecular system, so that the grid points existing in one periodic box are made apart by an influential outreach distance of an interaction kernel or greater from those existing in other periodic boxes.

11. The molecular simulation apparatus according to claim 10, wherein the size of the buffer area is determined by calculating the necessary minimum size, based on the kernel's influential outreach distance and the grid size.

12. A program product causing a computer which calculates non-bonding interactions in a system having particles with electric charges, using a multigrid method, to perform molecular simulation, to perform:
when assigning electric charges to grid points in a coarser grid of a higher level that is one step higher than the level to be observed,
the process of assigning the electric charges to neighboring grid points in the higher level, and the process of re-assigning the assigned electric charges to grid points of a broader range, and
when interpolating potential, electric field or force acting on the grid points in the observed level into the neighboring grid points in a finer grid of a lower level that is one step lower than the observed level,
the process of distributing the electric charges to grid points of a broader range in the observed level, prior to the interpolation.

13. The program product according to claim 12, further causing the computer to perform:
in order to handle an isolated molecular system in each grid system of a different level as a periodic system, the process of generating periodic boxes by adding extra empty buffer areas having no particle between boxes that each contain the isolated molecular system, so that the grid points existing in one periodic box are made apart by an influential outreach distance of an interaction kernel or greater from those existing in other periodic boxes, and
the process of determining the size of the buffer area by calculating the necessary minimum size, based on the kernel's influential outreach distance and the grid size.
